(19) United States
(12) Patent Application Publication
(10) Pub. No.: US 2007/0290404 A1
(43) Pub. Date: Dec. 20, 2007

(54) Process for making a framed electrode

(75) Inventors: David Hecht, Givatim (IL); Hannan Anderman, Zichron-Yaakob (IL); Nadav Bar-Or, Tel-Aviv (IL); Moti Meron, Hertzelia (IL); Aner Tsuk, Yatziz (IL)

Correspondence Address: GREENBLUM & BERNSTEIN, P.L.C., 1950 ROLAND CLARKE PLACE, RESTON, VA, 20191, US

(73) Assignee: More Energy Ltd., Lod (IL)

(21) Appl. No.: 11/452,199

(22) Filed: Jun. 14, 2006

(51) Int. Cl. B29C 45/14

(52) U.S. Cl. 264/279; 264/275; 264/328.1; 264/328.12; 264/328.18; 264/331.13

(57) ABSTRACT

A process for making a framed electrode by injection molding. The process comprises placing a flat piece of electrode material on a shrinkage-free under mold frame and attaching it thereto in a manner which substantially prevents the piece and the frame from moving relative to each other, over molding the resultant assembly by injecting a molten resin into an over molding cavity which contains the assembly, and allowing the resin to solidify. This Abstract is not intended to define the invention disclosed in the specification, nor intended to limit the scope of the invention in any way.

### BACKGROUND OF THE INVENTION

1. Field of the Invention

The present invention relates to a process for making a framed flat electrode and in particular, an electrode for use in a fuel cell.

2. Discussion of Background Information

Fuel cells and in particular, direct liquid fuel cells (DLFCs) are of considerable importance in the field of new energy conversion technologies. A liquid fuel cell usually comprises a fuel chamber, an electrolyte chamber and two electrodes, i.e., a cathode and an anode. The electrolyte chamber is located between the cathode and the anode and the fuel chamber is located at the side of the anode opposite the side of the electrolyte chamber. When the fuel cell is in operation the fuel is catalytically oxidized at the anode and another substance, often oxygen, is catalytically reduced at the cathode. Fuels based on (metal) hydride and borohydride compounds such as, e.g., sodium borohydride (e.g., in alkaline solution) have a very high chemical and electrochemical activity. For example, in the case of a borohydride fuel, the borohydride compound is electrochemically oxidized at the anode by direct reaction with formation of BO₂⁻ and water in accordance with the following equation:

BH₄⁻+8OH⁻=BO₂⁻+6H₂O+8e⁻.

An electrode of a liquid fuel cell may comprise a framed piece of electrode material. The framing may, for example, be accomplished by injection molding to provide a frame, usually of plastic material, around the piece of electrode material. An important issue in the injection molding process is the prevention of warping, i.e., to assure that the electrode material in the framed state is as flat as possible. If the framed electrode material is not flat, e.g., warped, this may cause a variety of problems. For example, the fuel cell may short (due to direct contact between anode and cathode) and/or may leak (incomplete sealing). Warping of the electrode material may, for example, be due to shrinkage issues inherent in the injection molding process, especially when dissimilar materials with different shrinkage factors are combined.

Another important factor to be considered in the injection molding process is the accurate positioning of the electrode material in the frame during the injection molding process, including addressing the placement of current collection. In particular, it must be assured that the electrode material does not substantially change its position relative to the framing material during the framing process and that the position of the current collector is not changed, either.

In view of the foregoing, an electrode framing process which results in a satisfactory framed electrode for use in a liquid fuel cell will preferably:
(i) provide the electrode material with a supporting frame which will enable it to be used as a component within an fuel cell assembly;
(ii) afford a leak tight seal of the electrode material which will enable it to be used in a fuel cell device that holds liquid phase chemical solutions; and
(iii) assure the flatness of the framed electrode material within the supporting frame.

Further, it will preferably also
(iv) accommodate means for collecting the electric charges generated by the electrochemical reaction within the fuel cell device and means for carrying the electric charges outside of the fuel cell.

### SUMMARY OF THE INVENTION

The present invention provides a process for producing a framed flat electrode by injection molding. The process comprises:

(a) placing a flat piece of electrode material on a shrinkage-free under mold frame and attaching it thereto in a manner which substantially prevents the piece and the under mold frame from moving relative to each other, thereby providing an under mold frame assembly;
(b) over molding the under mold frame assembly of (a) by injecting a molten resin into an over molding cavity which contains the assembly to (rapidly and substantially completely) fill the cavity with the molten resin, thereby providing a frame of resin on at least the electrode material side of the assembly; and
(c) allowing the injected resin to cool and solidify.

In one aspect of the process, the under mold frame may comprise a plastic material. For example, the plastic material of the under mold frame may comprise the same resin as the resin which is used for over molding the assembly.

In another aspect, the under mold frame may have been molded prior to the over molding operation and allowed to cool and solidify until it does not undergo any further shrinkage.

In another aspect, the piece of electrode material may be attached to the under mold frame by employing positioning features and/or heat stacking and/or welding. For example, the piece of electrode material and the under mold frame may both be provided with positioning features such as, e.g., a boss in the frame and a pilot hole in the piece of electrode material, with the position of the hole corresponding to the position of the boss of the frame. The boss may, for example, be fixed to the piece of electrode material by heat stacking.

In yet another aspect of the process of the present invention, the piece of electrode material may be attached to the under mold frame by employing welding, in particular, vibration welding.

In a still further aspect of the process, the over molding cavity may be filled with the molten resin within not more than about 10 seconds, e.g., within not more than about 5 seconds, within not more than about 2 seconds, within not more than about 1 second, within not more than about 0.5 seconds, or even within not more than about 0.2 seconds. This may, for example, be accomplished by using a multiple gating system with two or more (e.g., three, four, five or six) gates.

In another aspect of the process of the present invention, the flow of the molten resin into the over molding cavity at the gate points may be substantially perpendicular to the plane of the piece of electrode material.

In yet another aspect, the over molding cavity may be designed to allow shutoff against the piece of electrode material and the under mold frame.

In another aspect of the process, the molten resin may comprise a thermoplastic polymer such as, e.g., an acrylonitrile-butadiene-styrene (ABS) copolymer. The molten resin may further comprise a filler such as, e.g., fiberglass, carbon fiber, carbon dust and/or a ceramic material.

In a still further aspect of the process of the present invention, a current collector may be combined with (e.g., attached to) the piece of electrode material prior to attaching the piece to the under mold frame. For example, the current collector may be crimped onto the piece of electrode material and/or the current collector may comprise a conductive metal and/or an alloy thereof.

In another aspect, the electrode material may comprise carbon, an oxidation or reduction catalyst and a binder. The catalyst may comprise a metal and/or the binder may comprise a polymeric binder.

In yet another aspect, the electrode material may have been provided with a gas blocking layer on one side thereof and/or it may have been subjected to a hydrophilization treatment.

The present invention also provides a process for producing a framed flat electrode by injection molding, which process comprises

(a) placing a flat piece of electrode material combined with a current collector (e.g., attached thereto) on one side of a shrinkage-free under mold frame of a plastic material;
(b) attaching the piece of electrode material to the under mold frame by employing at least one of positioning features, heat stacking and welding to substantially prevent the piece and the frame from moving relative to each other, thereby providing an under mold frame assembly;
(c) over molding the under mold frame assembly by injecting a molten resin into an over molding cavity which contains the assembly by using a multiple gating system to substantially completely fill the cavity with the molten resin within not more than about 10 seconds, thereby providing a frame of resin on at least the electrode material side of the assembly; and
(d) allowing the injected resin to cool and solidify.

In one aspect of the process, the cavity may be filled with the molten resin within not more than about 2 seconds.

In another aspect of the process, the flow of the molten resin into the over molding cavity at the gate points may be substantially perpendicular to the plane of the piece of electrode material.

In yet another aspect, the over molding cavity may be designed to allow shutoff against the piece of electrode material, the current collector and the under mold frame.

In a still further aspect of the process, the plastic material and the molten resin may both comprise a thermoplastic polymer. For example, the thermoplastic polymer may comprise an acrylonitrile-butadiene-styrene (ABS) copolymer.

In another aspect of the process, the current collector may be attached to (e.g. crimped onto) the piece of electrode material.

The present invention also provides a framed flat electrode which is obtainable by the process of the present invention. For example, the framed electrode may be suitable for use in a (e.g., direct liquid) fuel cell.

The present invention further provides a liquid fuel cell which comprises the framed electrode which is obtainable by the process of the present invention. For example, the fuel cell may be a direct liquid fuel cell and may comprise a liquid fuel comprising a metal hydride and/or a borohydride compound.

The present invention also provides a method of providing a fuel cell with a framed electrode. The method comprises arranging the framed flat electrode which is obtainable by the process of the present invention inside the fuel cell structure. In one aspect, the electrode may be intended to serve (and may be designed) as an anode. In another aspect, the electrode may be intended to serve (and may be designed) as a cathode.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a piece of flat electrode material which is to be framed according to the process of the present invention;

FIG. 2 shows the piece of electrode material of FIG. 1 with a current collector attached thereto;

FIG. 3 shows an under mold frame for use in the process of the present invention;

FIG. 4 shows the positioning of the piece of electrode material of FIG. 2 and the under mold frame of FIG. 3;

FIG. 5 shows a partial cross-section of the finished framed electrode;

FIG. 6 shows a perspective view of the finished framed electrode;

FIG. 7 shows an explosion view of a framed electrode wherein the under mold frame includes an integrated supporting and/or protective structure;

FIG. 8 shows an under mold frame with an integrated supporting and/or protective structure; and

FIG. 9 shows the under mold frame of FIG. 8 with an electrode attached thereto.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The electrode material for use in the process of the present invention may be supplied in any suitable form. For example, it may be in the form of a roll, a sheet or a flat strip. It may have been formed by a wet process or by a dry process or a combination thereof. Before the material is used, it usually has to be converted into a piece of electrode material with the desired final dimensions. Preferably, this may be accomplished by various cutting technologies such as, e.g., die cutting, ruler die, laser, water jet etc. The cutting process will preferably provide a dimensional accuracy of the order of ±0.1 mm or less, especially if the framed electrode is to be used in a comparatively small device such as, e.g., a portable fuel cell. The dimensions of the cut piece of electrode material (which will often have a substantially rectangular shape) depend on device (e.g., fuel cell) for which the framed electrode is intended. The size of the piece will frequently be in the range of from about 5 cm² to about 2,000 cm², e.g., in the range of from about 10 cm² to about 100 cm², or in the range of from about 20 cm² to about 50 cm².

In some cases, especially when the electrode material is in the form of a roll, it may be desirable to employ a flattening operation to assure the flatness of the electrode material. Also, in some cases it may be advantageous to conduct pre-cutting or post-cutting forming. For example, such pre-cutting forming may be used in a cathode material cutting process with the specific intent of thickness gauging of the perimeters of the piece of electrode material.

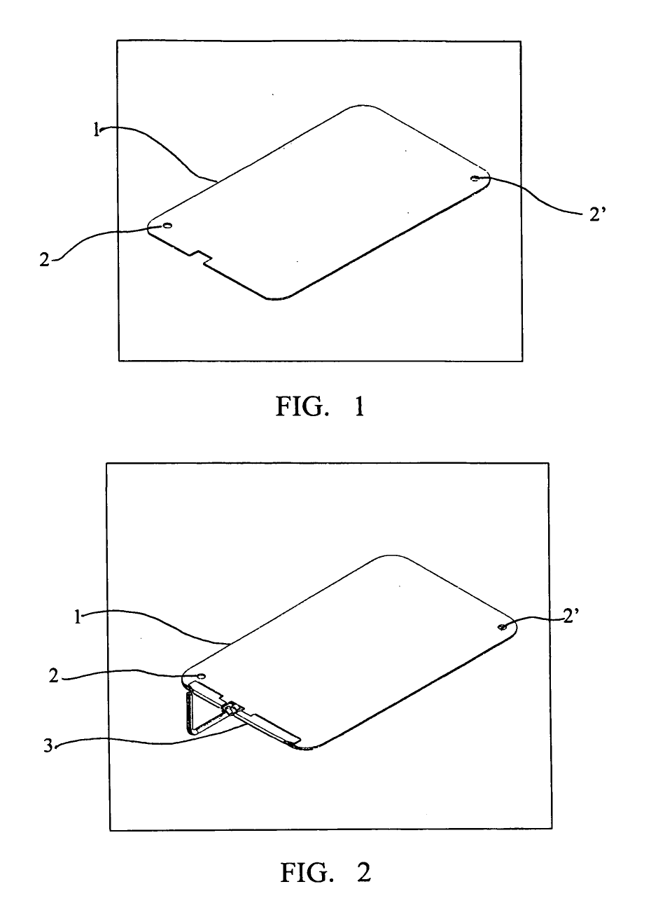

FIG. 1 shows a cut piece of electrode material 1 for framing according to the process of the present invention. Piece 1 is provided with two pilot holes 2, 2′ for accurate positioning and holding of the electrode assembly prior to and during the over molding operation and/or prior to or during the attachment of the current collector element 3 (FIG. 2).

Prior to subjecting the piece of electrode material 1 to the over molding operation, the piece usually is combined with a current collector element 3 (FIG. 2). The current collector element 3 is for collecting and carrying the electric charges, generated in, e.g., a fuel cell during an electrochemical reaction, from an electrode (i.e., anode or cathode) within the fuel cell housing to the outside of the fuel cell housing.

Current collector element 3 may, for example, comprise a sheet metal element produced in a punch and die forming process. Alternative and exemplary processes for making the sheet metal element include photochemical etching, wire erosion cutting and combinations thereof. Of course, any other types of current collectors may be used as well, such as, e.g., a metal grid (e.g., a nickel grid or a stainless steel grid), a metal foam, etc.

Highly conductive metals and alloys thereof usually are the materials of choice for producing the current collector element 3. Non-limiting examples of such metals and alloys include copper, brass, nickel, and copper-beryllium. Especially if these materials are not sufficiently corrosion resistant by themselves, they may be provided with a protective coating to reduce the risk of corrosion affecting the performance and shelf life of the current collector element 3. For example, in the case of an electrode which is intended for use in a liquid fuel cell using a borohydride compound as the fuel and an aqueous alkali metal hydroxide as the electrolyte, preferred materials for the current collector element 3 are those which are corrosion resistant in a (highly) alkaline environment.

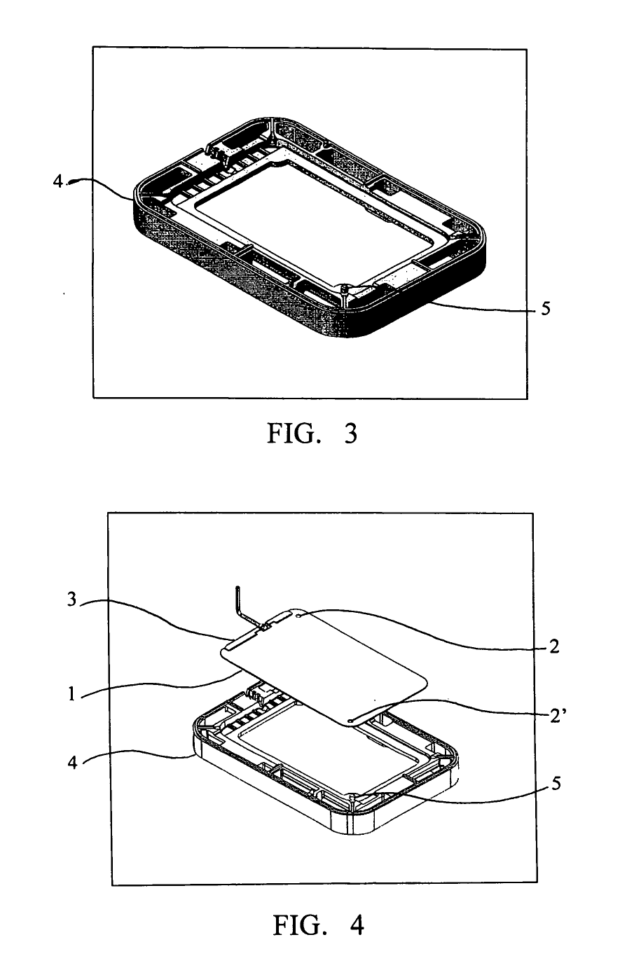

The current collector element 3 can be combined with (e.g., attached to) the piece of electrode material 1 in a variety of ways, to some extent also depending on the type of current collector element used. For example, in the case of a sheet metal element, the current collector element 3 may be crimped onto the piece of electrode material 1. The relative positioning of the current collector element 3 and the piece 1 are preferably kept in close tolerance to assure that the assembly of electrode material and current collector can be accurately positioned in the under mold frame 4 (FIG. 3).

It is pointed out that the current collector element 3 does not necessarily have to be attached (bonded) to the piece of electrode material 1 prior to the over molding operation. For example, the current collector element 3 may simply be placed on the piece 1. In this case, attachment (bonding) to the piece 1 is accomplished by the over molding operation, e.g., due to the molding pressure. Accordingly, attaching and/or bonding of the current collector element 3 to the piece 1 may be complete only after the over molding operation is complete.

The under mold frame 4 for use in the process of the present invention is illustrated in FIG. 3. It usually comprises a precision molded part which provides the (or at least the main) structure which holds the electrode in the fuel cell assembly. It usually is designed in such manner as to provide high structural strength and stability to assist in maintaining the straightness and flatness of the piece of electrode material 1 within the frame 4.

In most cases, the under mold frame 4 is made of a plastic material and will have been molded in a separate molding tool from the over molding tool (although this is not a requirement), and has been allowed to cool down completely to ensure that the shrinkage of the under mold frame 4 is complete before it is employed in the over molding operation. If the under mold frame 4 has been molded just prior to the framing process of the present invention, it is preferred to let the under mold frame cool and complete its shrinkage by letting it sit for at least about 4 hours, more preferably at least about 24 hours. In other words, the term “shrinkage-free” as used herein and in the appended claims means that the under mold frame is substantially preshrunk or has already undergone (and completed) shrinkage before it is combined with the piece of electrode material. (Of course, if the under mold frame 4 is made of a material that does not shrink, the under mold frame 4 would not have undergone any shrinkage before it is combined with the piece of electrode material 1, but can nevertheless be called “shrinkage-free” because it does not shrink). The completion of shrinkage and a full dimensional stability and accuracy of the under mold frame 4 greatly contribute to the production of a framed electrode with a liquid-tight seal and without warping and/or distortion of the electrode material.

The under mold frame 4 may be provided with one or more positioning features to facilitate the accurate positioning of the piece of electrode material 1 and the under mold frame 4 relative to each other and to keep these elements in place prior to and during the over molding operation. In the embodiment shown in FIG. 3, these positioning feature(s) take the form of (short) bosses 5. The position of the bosses 5 corresponds to the position of the pilot holes 2, 2′ in the piece of electrode material 1 (see FIG. 1). Of course, the positioning features which may be used according to the present invention are not limited to bosses and pilot holes. Any other positioning features which allow the accurate positioning of the piece of electrode material 1 and the under mold frame 4 relative to each other and assist in keeping these elements in their relative positions prior to and during the over molding operation may be used as well.

Using the positioning boss(es) 5 in the under mold frame 4 and the pilot holes 2, 2′ in the piece of electrode material 1, the piece of electrode material is accurately positioned in the under mold frame 4 (see FIG. 4). Heat staking may thereafter be used for forming the boss(es) 5 over the piece 1 and to fix the latter in its position relative to the under mold frame 4.

Those of skill in the art will appreciate that the use of positioning features such as, e.g., bosses and holes is only one of a number of methods which can be used to accomplish an accurate positioning of the under mold frame 4 and the piece of electrode material 1 relative to each other and to prevent any substantial movement of these two elements relative to each other prior to and during the over molding operation. Non-limiting examples of other methods which are suitable for this purpose include heat stacking, welding (e.g., vibration welding, ultrasonic welding, etc.), use of adhesives and combinations of two or more of these methods.

The over molding operation of the process of the present invention provides the sealing of the (preferably) plastic frame on the electrode and current collector elements. For example, the under mold frame assembly comprising the under mold frame 4 and the piece of electrode material 1 attached thereto may be placed in an over molding cavity. Preferably, the material (e.g., molten resin) used for providing the over mold part 6 of the frame is designed to allow penetration of the material into a porous structure at the circumference of the piece of electrode material 1 and to exert a high pressure clamping force created by the injection pressure of the material.

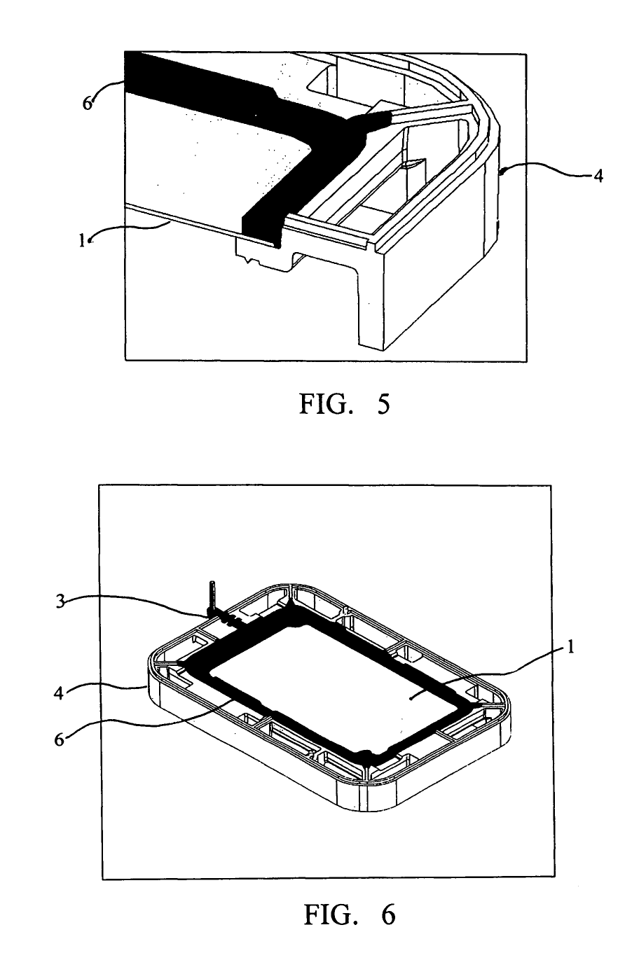

A multiple gating system is preferably used to assure a rapid filling of the over molding cavity with the molten resin. Specifically, the filling of the over molding cavity preferably is completed within about 10 seconds, more preferably within about 5 seconds, even more preferably within about 2 seconds. Shorter filling times such as, e.g., not more than about 1 second, not more than about 0.5 seconds or even not more than about 0.2 seconds may afford even better results with respect to e.g. sealing and prevention of warping. Also, the direction of the flow of molten resin into the over molding cavity at the gate points is preferably substantially perpendicular to the plane of the piece of electrode material 1. Both of these features contribute to a liquid-tight sealing of the over mold part 6 and the electrode assembly including the piece of electrode material 1 and the current collector element 3. Further, as illustrated in FIG. 5 and FIG. 6, the over molding cavity preferably is designed in a way which provides shutoff against the piece of electrode material 1, the current collector element 2 and the under mold frame 4.

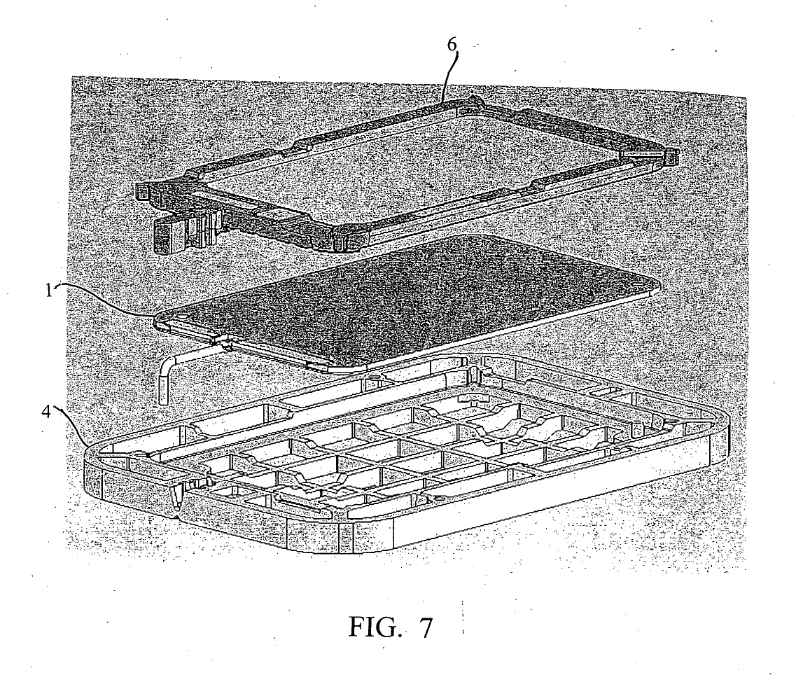

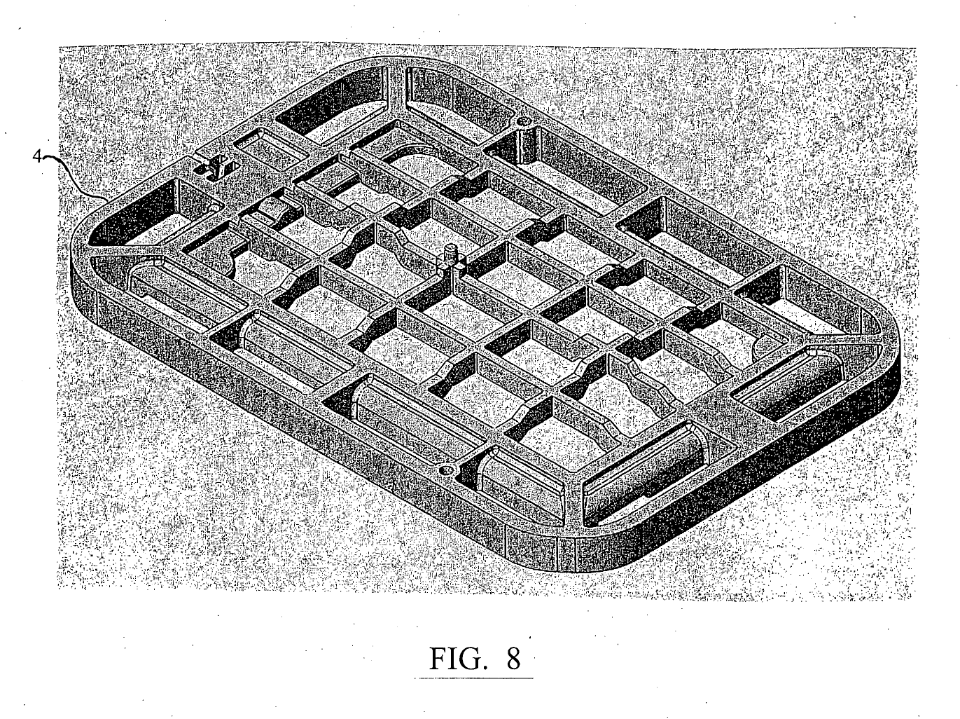

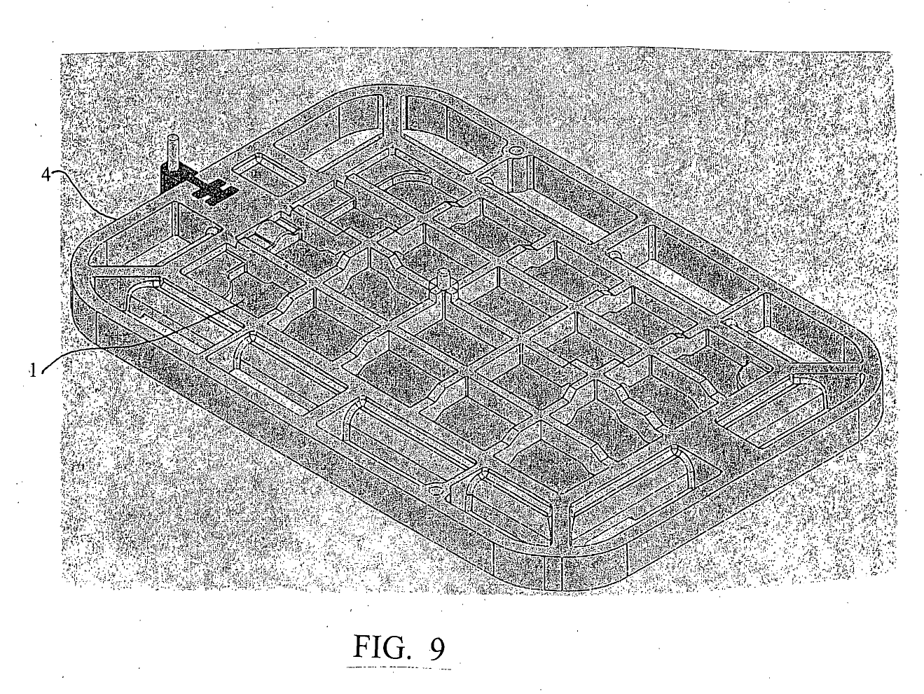

FIG. 7 shows an explosion view of a framed electrode wherein the under mold frame 4 is integral with a supporting and/or protective structure. The supporting and/or protective structure may, for example, take the form of a rib or grill structure. An under mold frame 4 having a supporting and/or protective structure integral therewith may be especially desirable in cases where the framed electrode is intended for use as a cathode such as, e.g., an air-breathing cathode. A corresponding under mold frame 4 may be (and preferably is) molded in one piece. Alternatively, a supporting and/or protective structure may, for example, be combined with the under mold frame 4 before or after the over molding operation (e.g., by gluing, welding, etc.). Of course, in the latter case it must be insured that this has no adverse effect on the flatness of the piece of electrode material 1. FIG. 8 shows an under mold frame 4 with integrated supporting and/or protective structure. FIG. 9 shows the same under mold frame 4 with a piece of electrode material 1 attached thereto.

The (polymeric) materials for making the under mold frame 4 and the materials for the over mold part 6 of the frame (i.e., the molten resin) are not particularly limited. They may be thermoplastic or thermoset, although they are preferably thermoplastic. Among the suitable materials, those with a low shrinkage factor are preferred. Preferred examples of materials for making both the under mold frame 4 and the over mold part 6 are acrylonitrile-butadiene-styrene (ABS) copolymers. However, other materials (polymers) may be used as well. Examples thereof include polycarbonate (PC) and polyolefins such as polyethylene (e.g., HDPE) and polypropylene. Of course, polymer blends may be used as well (e.g., PC/ABS blends). The selection of the framing materials for a particular intended use of the framed electrode is also influenced, to some extent, by the chemical stability of the materials toward the chemicals with which the framed electrode will come into contact.

One or more fillers may be added to the framing materials, for example, in order to improve the shrinkage of the latter. Non-limiting examples of suitable fillers include fiberglass, carbon fiber, carbon dust, ceramic materials and any combinations thereof. Of course, if a filler is conductive (such as, e.g., carbon) caution must be exercised so as to not use an amount of this filler which might cause problems such as, e.g., short-circuiting.

The ratio by weight of the material employed for the under mold frame 4 to the material employed for forming the over mold part 6 will often be from about 95:5 to about 60:40, e.g., from about 90:10 to about 70:30. Usually, the materials used for the under mold frame 4 and the over mold part 6 are the same (e.g., composed of the same polymeric material).

The electrode material for use in the present invention is not particularly limited. In a preferred embodiment, the material is suitable for use in a (direct liquid) fuel cell that uses a hydrophilic fuel such as, e.g., a borohydride fuel and/or an electrolyte which comprises an alkali or alkaline earth metal hydroxide (e.g., NaOH or KOH in the form of an aqueous solution or as a gel). The electrode material will often comprise a porous material and may have been produced by wet and/or dry technologies. Of course, if the framed electrode is intended for use in a liquid fuel cell, the electrode material should be able to withstand the chemical attack by the liquid fuel and/or the electrolyte and/or should not catalyze a decomposition of the fuel to any appreciable extent.

A non-limiting example of an electrode material for use in the present invention comprises activated carbon carrying a catalytically active material (such as a metal, for example, Pt, Pd, Ru, Rh, Ir, Re, Ni, Co, Ag and Au to name just a few), and a binder, typically a polymeric material such as, e.g., polytetrafluoroethylene. The material may have a current collector such as a metal mesh (made, e.g., of Ni or stainless steel) or a metal foam attached thereto. Of course, other and/or additional materials (such as, e.g., hydrophilic carbon paper) may be used for making the electrode material for use in the present invention.

Especially if the electrode material is intended for use as an anode material for a direct liquid fuel cell, the electrode material may have been provided with a gas blocking layer on one side thereof and/or may have been subjected to a hydrophilization treatment on one or both sides thereof. Of course, these treatments may also be carried out after the framing process of the present invention. Corresponding treatments are described in U.S. patent applications Nos. 10/959,763, 11/325,326 and 11/325,466, the entire disclosures whereof are expressly incorporated by reference herein.

Also, a framed anode made by process of the present invention may be used in combination with a device which substantially prevents fuel decomposition in a direct liquid fuel cell such as, e.g., the device disclosed in U.S. patent applications Nos. 10/941,020 and 11/226,222, the entire disclosures whereof are expressly incorporated by reference herein.

The framed electrodes obtainable by the process of the present invention preferably are suitable for use in fuel cells, in particular liquid fuel cells such as, e.g., DLFCs. DLFCs often use metal hydride and/or borohydride based fuels such as those described, e.g., in published U.S. applications US 2001/0045364 A1, US 2003/0207160 A1, US 2003/0207157 A1 and US 2003/0099876 A1, and in U.S. Pat. No. 6,554,877 B2 and U.S. Pat. No. 6,562,497 B2, the entire disclosures whereof are expressly incorporated by reference herein. It is pointed out that the use of the framed electrodes according to the present invention is not limited to fuel cells of any kind. Rather, these framed electrodes may be used in any device where framed electrodes may be employed such as, e.g., batteries and electrolytic cells.

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

What is claimed is:

1. A process for making a framed flat electrode by injection molding, wherein the process comprises
(a) placing a flat piece of electrode material on a shrinkage-free under mold frame and attaching it thereto in a manner which substantially prevents the piece and the frame from moving relative to each other, thereby providing an under mold frame assembly;
(b) over molding the under mold frame assembly by injecting a molten resin into an over molding cavity which contains the assembly to fill the cavity with the molten resin, thereby providing a frame of resin on at least an electrode material side of the assembly; and
(c) allowing the resin to solidify.

2. The process of claim 1, wherein the under mold frame comprises a plastic material.

3. The process of claim 2, wherein the plastic material of the under mold frame comprises the same resin as that which is used for over molding the assembly.

4. The process of claim 2, wherein the under mold frame has been molded and allowed to cool and solidify until it does not undergo any further shrinkage.

5. The process of claim 1, wherein the piece of electrode material is attached to the under mold frame by employing at least one of positioning features, heat stacking and welding.

6. The process of claim 5, wherein the piece of electrode material and the under mold frame are provided with positioning features.

7. The process of claim 6, wherein the under mold frame is provided with at least one boss and the piece of electrode material is provided with at least one hole whose position corresponds to a position of the at least one boss.

8. The process of claim 7, wherein the at least one boss is fixed to the piece of electrode material by heat stacking.

9. The process of claim 1, wherein the over molding cavity is filled with the molten resin within not more than about 10 seconds.

10. The process of claim 9, wherein the cavity is filled with the molten resin within not more than about 2 seconds.

11. The process of claim 1, wherein a multiple gating system comprising at least two gates is used for injecting the molten resin into the over molding cavity.

12. The process of claim 11, wherein the multiple gating system comprises at least about 4 gates.

13. The process of claim 11, wherein a flow of the molten resin into the over molding cavity at the gates is substantially perpendicular to a plane of the piece of electrode material.

14. The process of claim 1, wherein the over molding cavity is designed to allow shutoff against the piece of electrode material and the under mold frame.

15. The process of claim 1, wherein the molten resin comprises a thermoplastic polymer.

16. The process of claim 15, wherein the thermoplastic polymer comprises an acrylonitrile-butadiene-styrene (ABS) copolymer.

17. The process of claim 15, wherein the molten resin comprises a filler.

18. The process of claim 17, wherein the filler comprises at least one of fiberglass, carbon fiber, carbon dust and a ceramic material.

19. The process of claim 18, wherein a current collector is combined with the piece of electrode material prior to (b).

20. The process of claim 19, wherein the current collector is crimped onto the piece of electrode material.

21. The process of claim 19, wherein the current collector comprises at least one of a conductive metal and an alloy thereof.

22. The process of claim 1, wherein the electrode material comprises carbon, an oxidation or reduction catalyst and a binder.

23. The process of claim 22, wherein the catalyst comprises a metal.

24. The process of claim 22, wherein the binder comprises a polymeric binder.

25. The process of claim 1, wherein the electrode material is provided with a gas blocking layer on one side thereof.

26. The process of claim 1, wherein the electrode material has been subjected to a hydrophilization treatment.

27. A process for making a framed flat electrode by injection molding, wherein the process comprises
(a) placing a flat piece of electrode material combined with a current collector on one side of a shrinkage-free under mold frame of a plastic material;
(b) attaching the piece of electrode material to the under mold frame by employing at least one of positioning features, heat stacking and welding to substantially prevent the piece and the frame from moving relative to each other, thereby providing an under mold frame assembly;
(c) over molding the under mold frame assembly by injecting a molten resin into an over molding cavity which contains the assembly by using a multiple gating system comprising at least two gates to fill the cavity with the molten resin within not more than about 10 seconds, thereby providing a frame of resin on at least an electrode material side of the assembly; and
(d) allowing the resin to solidify.

28. The process of claim 27, wherein the cavity is filled with the molten resin within not more than about 1 second.

29. The process of claim 28, wherein a flow of the molten resin into the over molding cavity at the gates is substantially perpendicular to a plane of the piece of electrode material.

30. The process of claim 29, wherein the over molding cavity is designed to allow shutoff against the piece of electrode material, the current collector and the under mold frame.

31. The process of claim 27, wherein the plastic material and the molten resin comprise a thermoplastic polymer.

32. The process of claim 31, wherein the thermoplastic polymer comprises an acrylonitrile-butadiene-styrene (ABS) copolymer.

33. The process of claim 27, wherein the current collector is attached to the piece of electrode material.

34. A framed electrode which is obtainable by the process of claim 1.

35. The framed electrode of claim 34, wherein the electrode is suitable for use in a fuel cell.

36. A fuel cell, wherein the fuel cell comprises the framed electrode of claim 34.

37. The fuel cell of claim 36, wherein the fuel cell is a direct liquid fuel cell and comprises a liquid fuel comprising at least one of a metal hydride and a borohydride compound.

38. A method of providing a fuel cell with a framed electrode, wherein the method comprises arranging inside a fuel cell housing the framed electrode of claim 34.

39. The method of claim 38, wherein the framed electrode is designed for use as an anode.

40. The method of claim 38, wherein the framed electrode is designed for use as a cathode.
